(19) United States
(12) Patent Application Publication
(10) Pub. No.: US 2013/0258267 A1
(43) Pub. Date: Oct. 3, 2013

(54) METHOD FOR FABRICATING MESOPOROUS OXIDE HOLLOW PARTICLES AND THE LIQUID CRYSTAL DEVICE COMPRISING THE SAME

(71) Applicant: INNOLUX CORPORATION, Miao-Li County (TW)

(72) Inventors: Ching-Chao CHANG, Miao-Li County (TW); Kuang-Yao Lo, Miao-Li County (TW); Hong-Ping Lin, Miao-Li County (TW)

(73) Assignee: InnoLux Corporation, Miao-Li County (TW)

(21) Appl. No.: 13/804,502

(22) Filed: Mar. 14, 2013

(30) Foreign Application Priority Data
Mar. 29, 2012 (TW) 101111000

(51) Int. Cl. G02F 1/00

(52) U.S. Cl. CPC G02F 1/0045
USPC 349/182; 427/213.31

(57) ABSTRACT

The disclosure provides a method for fabricating a mesoporous oxide hollow particle and a liquid crystal device including the same. The liquid crystal device includes: a first substrate; a second substrate; and a liquid crystal composition formed between the first substrate and the second substrate, wherein the liquid crystal composition includes a liquid crystal molecule and a mesoporous oxide hollow particle.

### CROSS REFERENCE TO RELATED APPLICATIONS

This Application claims priority of Taiwan Patent Application No. 101111000, filed on Mar. 29, 2012, the entirety of which is incorporated by reference herein.

### BACKGROUND

1. Field of the Disclosure

The present disclosure relates to mesoporous oxide hollow particles, and in particular, relates to a liquid crystal display comprising the mesoporous oxide hollow particles.

2. Description of the Related Art

Liquid crystal molecules are dispersed in an organic polymer matrix to form a polymer-dispersed liquid crystal (PDLC), wherein in the refractive index of the liquid crystal molecules mismatch with that of the organic polymer. In the absence of an electric field, a non-transparent scene is formed because the light is scattered by the liquid crystal molecules in the polymer matrix. In the presence of an electric field, the liquid crystal molecules are orientated to the direction of the electrical field and the refractive index of the liquid crystal molecules is changed to match with that of the organic polymer, thus a transparent scene is formed. A polarizing film and an alignment film are not needed in the polymer-dispersed liquid crystal (PDLC), and thus a PDLC may be applied to production of large-size liquid crystal displays, such as banners or smart windows.

The methods for fabricating the polymer-dispersed liquid crystal (PDLC) include: (1) polymerization induced phase separation; (2) temperature induced phase separation; (3) solvent induced phase separation; and (4) microencapsulation, etc. In methods (1)-(3), the liquid crystal molecules and the polymers are firstly phase-separated and then the liquid crystal molecules are formed in the polymer matrix. In the method (4), the liquid crystal molecules and the monomers are mixed to form a mixture. Then, the monomers are polymerized by adding a binder into the mixture. The liquid crystal molecules are confined in the polymer to form liquid crystal capsules.

However, the polymer-dispersed liquid crystal (PDLC) may be exposed to sunlight for a long time, and thus the polymers may deteriorate. Additionally, the conventional method for fabricating the polymer-dispersed liquid crystal (PDLC) is tedious.

In order to resolve the above-mentioned problems, the disclosure provides a liquid crystal display comprising the mesoporous oxide hollow particles.

### BRIEF SUMMARY

The disclosure provides a method for fabricating a mesoporous oxide hollow particle, comprising: (a) mixing a template, a surfactant and a solvent to form a mixture solution, wherein the surfactant is formed on a surface of the template; (b) adding an inorganic particle into the mixture solution to conduct a sol-gel reaction to form an inorganic oxide having a core-shell structure; and (c) removing the template and the surfactant to form the mesoporous oxide hollow particle.

The disclosure also provides a liquid crystal display, comprising: a first substrate; a second substrate; and a liquid crystal composition formed between the first substrate and the second substrate, wherein the liquid crystal composition comprises a liquid crystal molecule and a mesoporous oxide hollow particle.

A detailed description is given in the following embodiments with reference to the accompanying drawings.

### BRIEF DESCRIPTION OF THE DRAWING

For a more complete understanding of the present disclosure, and the advantages thereof, reference is now made to the following descriptions taken in conjunction with the accompanying drawings, in which:

FIG. 1 shows a cross-sectional schematic representation of a liquid crystal display in accordance with an embodiment of the disclosure;

FIG. 2 shows a transmission electron microscopy (TEM) pattern of the Example 1 of the disclosure; and

FIG. 3 shows a relationship between an applied voltage (V) and the transmittance (%) of the liquid crystal display.

### DETAILED DESCRIPTION

The following description is of the best-contemplated mode of carrying out the disclosure. This description is made for the purpose of illustrating the general principles of the disclosure and should not be taken in a limiting sense. The scope of the disclosure is best determined by reference to the appended claims.

The disclosure provides a method for fabricating mesoporous oxide hollow particles comprising steps (a)-(c). Firstly, in step (a), a template, a surfactant and a solvent are mixed to form a mixture solution, wherein the surfactant is formed on a surface of the template.

The template comprises a polymethylmethacrylate (PMMA), polystyrene (PS) or polymer ball. The template has a size of about 100 nm-2000 nm, and preferably about 300-700 nm. The size of the mesoporous oxide hollow particles may be affected by the size of the template.

The surfactant comprises a gelatin, block polymer, long chain surfactant or combinations thereof The block polymer comprises a polyoxyethylene-polyoxyoropylene block polymer or polyethylene glycols (PEG). The polyethylene glycols (PEG) comprises a poloxamer 403 (P123), poloxamer 407 (F127), poloxamer 402 (L122), poloxamer 181 (L61), poloxamer 401 (L121), poloxamer 185(P65), PE64 or poloxamer 338 (F108).

The long chain surfactant comprises C₈-C₂₀ alkyl anionic surfactant, C₈-C₂₀ alkyl cationic surfactant or combinations thereof The C₈-C₂₀ alkyl anionic surfactant comprises sodium dodecyl sulfate (SDS) or sodium dodecylbenzene sulfonate (SDBS). The C₈-C₂₀ alkyl cationic surfactant comprises cetyl trimethylammonium bromide (CTMAB), dodecyl trimethyl ammonium bromide (DTMAB), cetyl trimethylammonium chloride (CTMAB), octadecyl trimethylammonium bromide (OTMAB) or octadecyl trimethylammonium chloride (OTMAC).

The solvent comprises water, ethanol, isopropanol, propanol, actone, toluene, 1,3,5-trimethylbenzene, polar solvent, non-polar solvent or combinations thereof The choice of the solvent is dependent on the kind of the surfactant, and the solvent is not limited to the above-mentioned solvents.

Then, in step (b), the inorganic particles are added into the mixture solution to conduct a sol-gel reaction to form an inorganic oxide having a core-shell structure. The sol-gel reaction is conducted under a pH value of about 4-6.

Note that a condensation reaction is conducted to the inorganic particles on the surface of the template with the help of the surfactant. Thus, the inorganic oxide having the core-shell structure is formed. Additionally, the weight ratio of the surfactant to the inorganic particles is about 1/10-10/1, and preferably about 1/5-5/1.

Furthermore, before step (c), the method further comprises conducting a hydrothermal reaction to the inorganic oxide, wherein the hydrothermal reaction is conducted at temperature of about 50° C.-200° C. for about 1 hour-200 hours.

The inorganic oxide may be dissolved and re-crystallized to form a stable inorganic oxide. The hydrothermal reaction is preferably conducted under an acid condition, with a pH value of about 4-6.

Then, in step (c), the template and the surfactant are removed to form the mesoporous oxide hollow particles. The template and the surfactant are removed by conducting a calcination process to the inorganic oxide.

In one embodiment, the inorganic oxide is put in a furnace at 300-800° C. to conduct the calcination process. Thus, when the template and the surfactant are removed, the mesoporous oxide hollow particles are formed.

According to the regulations of international union of pure and applied chemistry (IUPAC), the porous materials are classified into three types according to the average pore diameter of the porous material. The pores having a pore size larger than about 50 nm is defined as macroporous. The pores having a pore size about 2-50 nm is defined as mesoporous. The pores having a pore size smaller than about 2 nm is defined as microporous. Thus, the term “mesoporous oxide hollow particles” used in the disclosure means that the oxide hollow particles have a pore size of about 2-50 nm.

The mesoporous oxide hollow particles formed by the above method comprise silicon oxide, aluminum oxide, titanium oxide, zinc oxide or inorganic oxide.

Moreover, a surface modification may be applied to the mesoporous oxide hollow particles of the disclosure to change the surface property of the mesoporous oxide hollow particles.

In one embodiment, the silicon oxide hollow particles are modified with silane compounds, and thus the surface of the silicon oxide hollow particles is changed from hydrophilic to hydrophobic.

The mesoporous oxide hollow particles formed by the above method have a refractive index of about 1.40-1.50 and an average pore size of about 100 nm-2000 nm, and preferably about 300 nm-700 nm.

From the above description, the well-dispersed mesoporous oxide hollow particles are formed by a solid template. The size of the mesoporous oxide hollow particles is dependent on the size of the template. The dispersion of the mesoporous oxide hollow particles is defined by the amount of the surfactant and the inorganic particles.

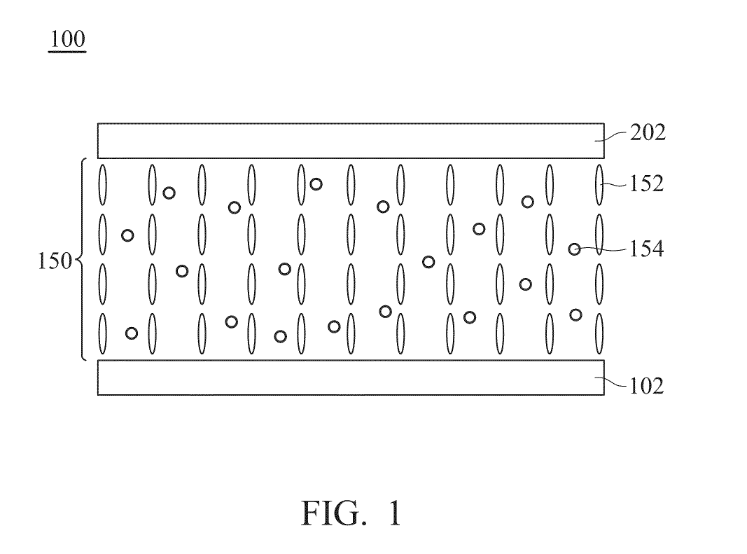

Referring to FIG. 1, the disclosure also provides a liquid crystal display 100. The liquid crystal display 100 comprises a first substrate 102; a second substrate 202; and a liquid crystal composition 150 formed between the first substrate 102 and the second substrate 202, wherein the liquid crystal composition 150 comprises a liquid crystal molecules 152 and a mesoporous oxide hollow particles 154. Note that the first substrate 102 and the second substrate 202 may be a thin film transistor substrate, color filter substrate, transparent substrate or a composite substrate of a thin film transistor substrate with color filter.

The mesoporous oxide hollow particles 154 are formed by the above-mentioned method. The mesoporous oxide hollow particles 154 have a refractive index of about 1.40-1.50 and an average pore size of about 100 nm-2000 nm.

Furthermore, the weight ratio of the liquid crystal molecules 152 to the mesoporous oxide hollow particles 154 is about 0.01-1. The liquid crystal molecules 152 may enter into the hollow position of the mesoporous oxide hollow particles 154. Thus, the density difference between the mesoporous oxide hollow particles 154 and the liquid crystal molecules 152 is decreased, and the dispersion of the liquid crystal molecules 152 is improved.

The liquid crystal molecules 152 comprise Nematic liquid crystals, Smectic liquid crystals or Cholesteric liquid crystals. The Nematic liquid crystal comprises commercially obtained MLC6080, BLOO6 or ZLI4792, and the Smectic liquid crystal is such as CS1031, and the Cholesteric liquid crystal is such as CB-15. In addition to the above-mentioned liquid crystal molecules, other liquid crystal molecules are all included in the scope of the disclosure.

Additionally, the refractive index of the liquid crystal molecules is adjusted to be close to that of the mesoporous oxide hollow particles by rotating the liquid crystal molecules by an applied voltage. Therefore, the transmittance of the liquid crystal display is changed by adjusting the refractive index of the liquid crystal molecules. The photoelectrical characteristics of the liquid crystal display are adjusted by changing the concentration of the mesoporous oxide hollow particles. Thus, a linear relationship is formed between the applied voltage and the transmittance of the liquid crystal display, and the liquid crystal display has advantages of high transmittance or high reflectivity.

In prior art, the polymer-dispersed liquid crystal (PDLC) may be exposed to sunlight for a long time, and thus the polymers may deteriorate. Note that the mesoporous oxide hollow particles of the disclosure are easy to fabricate and have a high stability (will not deteriorate when exposed for a long period to sunlight). Thus, the lifespan of the liquid crystal display may be increased.

The liquid crystal display of the disclosure may be used in transmissive displays, reflective displays or transflective displays.

### EXAMPLE

### Example 1

### Fabrication of Mesoporous Silicon Oxide Hollow Particles

0.50 g of polymethylmethacrylate (PMMA) powders (with a diameter of about 300 nm) were dissolved in water and sonicated for 3 hours and then the resulting mixture was mixed for 3 hours. The polymethylmethacrylate (PMMA) was well dispersed in water to form a first solution.

0.15 g of gelatin (as a solid template) was dissolved in water to form a second solution. The second solution was poured into the first solution to form a third solution. The third solution was sonicated for 3 hours and then the resulting mixture was mixed for 3 hours.

Next, a sodium silicate solution with a pH value of 4 was poured into the third solution to conduct a sol-gel reaction for 6 hours, and then a hydrothermal reaction at 100° C. for 24 hours, and then a calcinations process at 500° C. for 3 hours.

Then, the gelatin (as a solid template) was removed to form the mesoporous silicon oxide hollow particles.

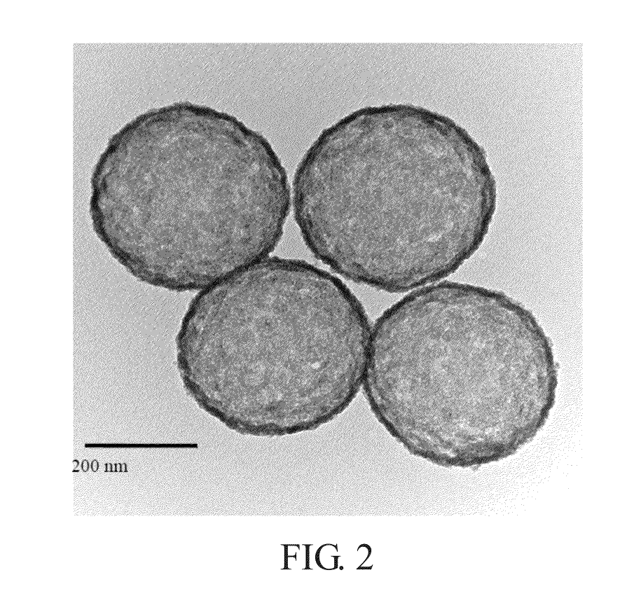

FIG. 2 shows a transmission electron microscopy (TEM) pattern of the Example 1. As shown in FIG. 2, the silicon oxide had a hollow structure.

### Example 2

The experimental condition of Example 2 was the same as that of the Example 1, except that the surfactant in Example 2 was cetyl trimethylammonium chloride (CTMAB).

The experimental data of Example 2 showed that the silicon oxide had a hollow structure.

### Example 3

The experimental condition of Example 3 was the same as that of the Example 1, except that the surfactant in Example 3 was 0.15 g of PEG10000.

The experimental data of Example 3 showed that the silicon oxide had a hollow structure.

### Example 4

The experimental condition of the Example 4 was the same as that of the Example 1, except that the surfactant in Example 4 was 0.15 g of PEG300000.

The experimental data of Example 4 showed that the silicon oxide had a hollow structure.

### Example 5

### Fabrication of Liquid Crystal Display

A liquid crystal composition was formed by mixing the mesoporous silicon oxide hollow particles of Example 1 and the liquid crystal molecules MLC6080 in a weight ratio of 0.00625 g/0.2 g.

The liquid crystal composition was filled into a space between the thin film transistor substrate and color filter substrate to form a liquid crystal display.

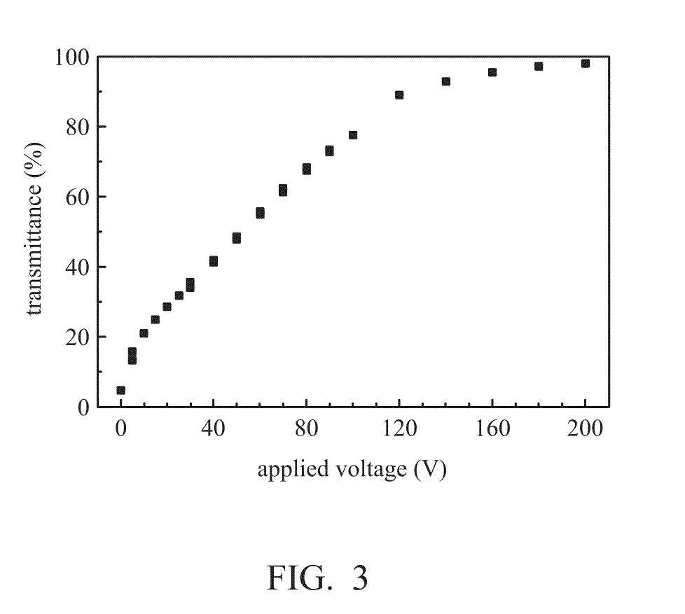

FIG. 3 shows a relationship between an applied voltage (V) and the transmittance (%) of the liquid crystal display. As shown in FIG. 3, a linear relationship is formed between the applied voltage and the transmittance of the liquid crystal display.

### Example 6

### Fabrication of Liquid Crystal Display

The surface of the mesoporous silicon oxide hollow particles of Example 2 was modified with trimethylchlorosilane (ClSi(CH₃)₃). The modified method is described as follows.

The mesoporous silicon oxide hollow particles of Example 2 were added into an ethanol solution containing a hydrophobic silane to form a mixture. The mixture was refluxed for 3-5 hours and then dried to form the hydrophobic mesoporous silicon oxide hollow particles.

A liquid crystal composition was formed by mixing the hydrophobic mesoporous silicon oxide hollow particles of Example 2 and the liquid crystal molecules MLC6080 in a weight ratio of 0.005 g/0.2 g.

The liquid crystal composition was filled into a space between the thin film transistor substrate and color filter substrate to form a liquid crystal display.

The experimental data showed that the liquid crystal display of Example 6 had a lower driving voltage than that of Example 5, because the interaction between the mesoporous silicon oxide hollow particles and the liquid crystal molecules decreased due to the hydrophobic trimethylchlorosilane (ClSi(CH₃)₃).

While the disclosure has been described by way of example and in terms of the preferred embodiments, it is to be understood that the disclosure is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method for fabricating a mesoporous oxide hollow particle, comprising:
(a) mixing a template, a surfactant and a solvent to form a mixture solution, wherein the surfactant is formed on a surface of the template;
(b) adding an inorganic particle into the mixture solution to conduct a sol-gel reaction to form an inorganic oxide having a core-shell structure; and
(c) removing the template and the surfactant to form the mesoporous oxide hollow particle.

2. The method for fabricating a mesoporous oxide hollow particle as claimed in claim 1, wherein the template comprises a polymer ball.

3. The method for fabricating a mesoporous oxide hollow particle as claimed in claim 2, wherein the template comprises a polymethylmethacrylate (PMMA) or polystyrene (PS).

4. The method for fabricating a mesoporous oxide hollow particle as claimed in claim 1, wherein the surfactant comprises a gelatin, block polymer, long chain surfactant or combinations thereof.

5. The method for fabricating a mesoporous oxide hollow particle as claimed in claim 1, wherein the mesoporous oxide hollow particle is inorganic oxide.

6. The method for fabricating a mesoporous oxide hollow particles as claimed in claim 5, wherein the mesoporous oxide hollow particle comprises silicon oxide, aluminum oxide, titanium oxide or zinc oxide.

7. The method for fabricating a mesoporous oxide hollow particle as claimed in claim 1, wherein the solvent comprises a polar solvent or non-polar solvent.

8. The method for fabricating a mesoporous oxide hollow particle as claimed in claim 7, wherein the solvent comprises water, ethanol, isopropanol, propanol, actone, toluene, 1,3,5-trimethylbenzene or combinations thereof.

9. The method for fabricating a mesoporous oxide hollow particle as claimed in claim 1, wherein the sol-gel reaction is conducted under a pH value of about 4-6.

10. The method for fabricating a mesoporous oxide hollow particle as claimed in claim 1, wherein the weight ratio of the surfactant to the inorganic particle is about 1/10-10/1.

11. The method for fabricating a mesoporous oxide hollow particle as claimed in claim 1, before step (c), further comprising:
conducting a hydrothermal reaction to the inorganic oxide, wherein the hydrothermal reaction is conducted at temperature of about 50° C.-200° C. for about 1 hour-200 hours.

12. The method for fabricating a mesoporous oxide hollow particle as claimed in claim 1, wherein the mesoporous oxide hollow particle has a refractive index of about 1.40-1.50.

13. The method for fabricating a mesoporous oxide hollow particles as claimed in claim 1, wherein the mesoporous oxide hollow particle has a pore size of about 100 nm-2000 nm.

14. A liquid crystal display, comprising:
a first substrate;
a second substrate; and
a liquid crystal composition formed between the first substrate and the second substrate, wherein the liquid crystal composition comprises a liquid crystal molecule and a mesoporous oxide hollow particle.

15. The liquid crystal display as claimed in claim 14, wherein the mesoporous oxide hollow particle has a refractive index of about 1.40-1.50.

16. The liquid crystal display as claimed in claim 14, wherein the weight ratio of the liquid crystal molecule to the mesoporous oxide hollow particle is about 0.01-1.

17. The liquid crystal display as claimed in claim 14, wherein the mesoporous oxide hollow particle has an average pore size of about 100 nm-2000 nm.

18. The liquid crystal display as claimed in claim 14, wherein the mesoporous oxide hollow particle is inorganic oxide.

19. The liquid crystal display as claimed in claim 18, wherein the mesoporous oxide hollow particle comprises silicon oxide, aluminum oxide, titanium oxide or zinc oxide.

20. The liquid crystal display as claimed in claim 14, wherein the liquid crystal display comprises a transmissive display, reflective display or transflective display.
